(19) United States
(12) Patent Application Publication
(10) Pub. No.: US 2025/0115416 A1
(43) Pub. Date: Apr. 10, 2025

(54) BEVERAGE CAPSULE RECYCLER

(71) Applicants: Leslie GORT-BARTEN, Crawley (GB); Alex GORT-BARTEN, Crawley (GB)

(72) Inventors: Leslie GORT-BARTEN, Crawley (GB); Alex GORT-BARTEN, Crawley (GB)

(21) Appl. No.: 18/836,065

(22) PCT Filed: Feb. 10, 2023
(86) PCT No.: PCT/EP2023/053404

§ 371 Date: Aug. 6, 2024

(30) Foreign Application Priority Data
Feb. 10, 2022 (GB) 2201757.8

(51) Int. Cl. B65D 85/804; B09B 3/00

(52) U.S. Cl. CPC B65D 85/8046; B09B 3/00; B30B 9/321; B65D 83/76

(57) ABSTRACT

A device for separating beverage capsules, in particular coffee, comprises a base unit (10) and a pusher (22). The base unit (10) has a face with an opening (16) for receiving a used capsule, and the pusher (22) comprises a projection sized to fit within the opening (16), which has a stepped profile. In use, the pusher (22) inverts the capsule. The stepped profile significantly reduces the force required to invert the capsule enabling larger or multiple capsules to be inverted.

The invention relates to devices for assisting in the recycling of single-serve beverage capsules.

Powered espresso machines are well known. The conventional espresso machine comprises a water chamber, a heating element adapted to heat the water to around 95-98 C, which is then pumped under high pressure of 15 to 19 bar to a filter holder or portafilter. Lower pressure systems also exist. The filter holder typically comprises a handle portion and a holder portion provided with two or three lugs that are adapted to engage in the installed position with the machine brewhead to where the water is pumped. The holder portion is adapted to receive a filter, which is usually a metal bowl with a number of perforations through its bottom. In use, the filter is filled with finely ground coffee and the water is forced through the coffee at the high pressure generated by the pump to produce the espresso coffee which is collected in a cup placed under the filter holder.

The classic coffee machine suffers from two potential drawbacks. The first drawback is that ground coffee starts to lose its freshness and flavour after a few days and so for the optimum espresso, the user will also need to have a coffee grinder. The other drawback is that the used espresso coffee has to be removed from the filter, which can lead to mess as the grinds are fine.

This lead to the development of ESE coffee pods, which can be used in many espresso machines. Coffee pods are generally individually wrapped to maintain freshness and consist of a small pod made of a perforated filter paper which contains the coffee. The pod is placed in the filter holder and then disposed of after use. Coffee pods are convenient but have to fit the filter holder and be placed correctly otherwise water can leak around the edge.

This in turn lead to the development of capsule machines. The coffee capsules for these machines are completely sealed. The capsule machines do not use the conventional filter holder. A capsule machine typically has a two part mechanism. The first part receives the capsule and is provided with an extraction surface upon which the capsule rests. The second part is provided with a locking lever which is used to make the first and second parts integral. In use, the second part cuts the upper surface of the capsule to allow water to enter the capsule and percolate down through the capsule, where it exits through the lower surface of the capsule at multiple locations determined by the geometry of the extraction surface. An example of such a machine is disclosed in EP 0870457 or WO2005/004683. Capsules in the known capsule coffee machines are, in use, inserted into a capsule cage of the machine which holds the capsule in position so that it may be cut by a cutting member.

Capsule machines have proved to be commercially very successful as they are very convenient to use and produce a consistent product. However, each manufacturer's coffee machines and capsules are designed to work with the manufacturers own brand. The most popular brand of capsule is Nespresso®, which uses a sealed capsule made of aluminium. The original Nespresso capsule is disclosed in EP051214 and the current iteration in EP1654966.

More recently, a new system, called Vertuo has been introduced. The Vertuo capsules are extracted by a centrifugal process. The Vertuo capsule is made from formed aluminium and is enclosed by a plasticised aluminium foil lid. Unlike the original Nespresso capsule system, Vertuo capsules come in different sizes and the net coffee weight ranges from 5.5 grams through to 13 grams. The aluminium packaging weight (inc. lid foil) are 1.54 g for the small, 1.75 g from the medium and 1.91 g for the large, compared to the 0.94 grams for an original Nespresso capsule. Details of the Vertuo system can be found in WO2013171238.

A particular problem with known aluminium capsules is that the silicone seal means that the capsule cannot be recycled easily despite the significant ecological benefit in recycling aluminium and they are not recyclable in normal kerbside mixed collections. Special collection of the capsules negate the benefits of recycling.

ES 1241931U discloses a four part device for separating capsules comprising a lower cylindrical tank with a vessel configuration, in whose upper open end a ring-shaped piece is inserted by means of a screw or pressure. The latter has a hole with the diameter equal to the larger diameter of the capsule cone, and a stepped recess in said hole sufficient to support and centre the capsule disc. The third piece is the cylindrical upper body with the shape of an inverted vessel, which has a diameter slightly larger than the lower cylinder, so that, together, one cylinder slides inside the other as a piston sleeve. This upper body has inside its bottom, and integral to it, a frustoconical punch with the shape of the capsule in an inverted position, and a perforation along the longitudinal axis, where the fourth piece that is the sliding ejector is housed. The moveable ejector is required to prevent the capsule from sticking on the plunger. It also requires significant effort to use.

GB2586618 discloses a device for separating beverage capsules comprising a base unit and a plunger, the base unit having a face with an aperture for receiving a body part of the capsule, wherein a portion of the face surrounding the aperture has a surface that undulates in a longitudinal direction relative to a central axis through the aperture; the plunger comprising a projection sized to fit within the aperture. A capsule can be placed, rim side down, on the base unit over the aperture, and the plunger used to urge the capsule down into the aperture. The result is that the capsule inverts, rupturing the foil layer and emptying the coffee or other residue into the base unit below the aperture. The coffee or residue and the capsule can then be removed for separate recycling. This device has proven to be successful but can only recycle a single Nespresso original capsule at a time and cannot be adapted to process multiple capsules simultaneously or the Vertuo capsule as the downward pressure required is too great.

The present invention therefore seeks to provide an improved capsule recycling device.

According to the invention there is provided a device for separating beverage capsules, comprising a base unit and a pusher, the base unit having a face with an aperture for receiving a body part of the capsule, wherein the pusher comprising a projection sized to fit within the aperture, the projection having a stepped profile.

Preferred embodiments of the capsule are disclosed in the sub-claims.

The devices of the invention enable an increased number and/or variety of capsules and their residues to be recycled, separately, in kerbside collections.

The collar opening and the plunger has a greater clearance compared to the competitors which reduces the push force required for inversion. Decreasing the diameter of plunger allows a greater amount of force to be applied due to its smaller surface area allowing inversion to be easier compared to known plungers.

Exemplary embodiments of the invention will now be described with reference to the drawings, in which:

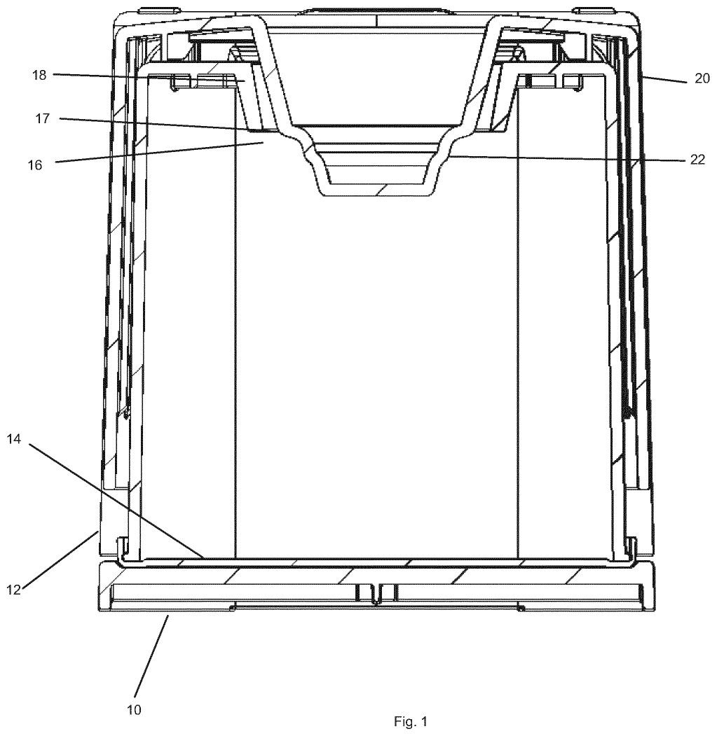

FIG. 1 shows a cross sectional view of a first embodiment of the capsule recycler;

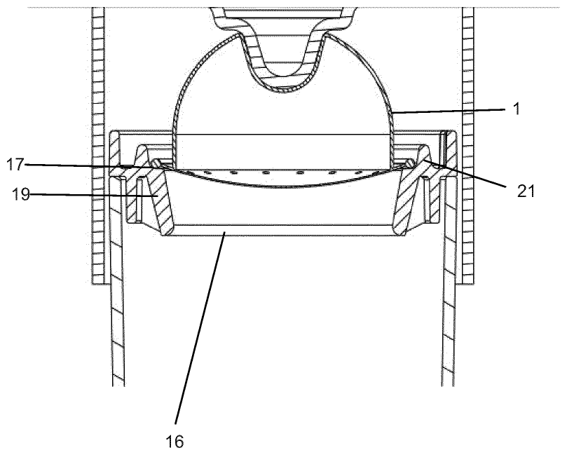

FIG. 2 shows a part of the recycler.

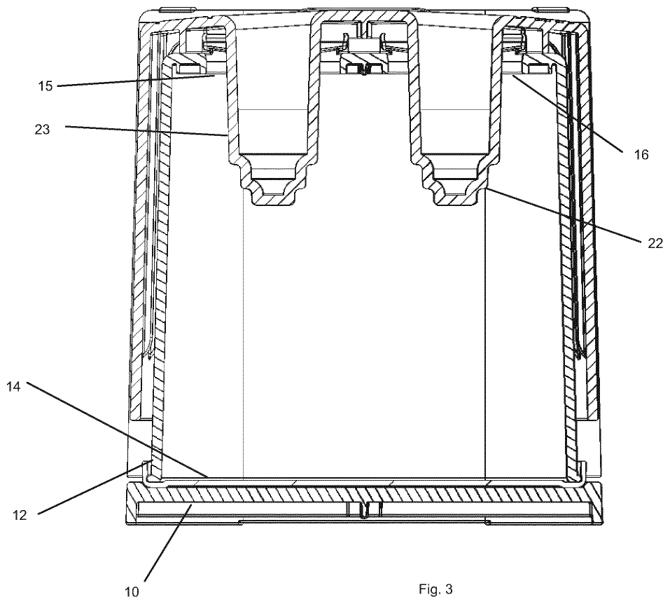

FIG. 3 shows a further embodiment of the invention.

FIG. 1 shows a cross sectional view of the recycler suitable for use with Vertuo capsules. The recycler comprises a base unit 10 upon which sits a receptacle 12. The lower face 14 of the receptacle 12 is openable and the upper face is provided with an opening 16 which has a downwardly depending collar 18 which is provided with a flange 17. The upper part 20 of the recycler functions as a lid and is provided with a pusher 22, which is substantially co-axial with the opening 16. The pusher comprises a projection sized to fit within the aperture, the projection having a stepped profile. The pusher is dimensioned so that there is a gap or clearance, exemplarily approximately 4-6 mm, preferably around 5 mm, between the surface of the pusher and the surface of the opening. In a typical capsule, the aluminium is between 0.075 to 0.125 mm thick. There is therefore a clearance between the pusher and opening when inverting the capsule.

FIG. 2 shows a part of the collar in more detail. The collar part comprises a main body 19 within which the opening 16 is formed. The opening 16 has a reducing cross-section towards its lower face. An upstanding circumferential wall 21 is provided a short distance from the edge of the opening 16 to provide the flange 17. In use a capsule 1 sits on the flange 17 prior to recycling with the edge of the capsule flange abutting the upstanding wall 21. When a downward force is applied to the capsule, the upstanding wall allows the angle between the lower face of the capsule and the collar to increase, which in turn increases the tension on the foil closing the capsule. Preferably the edge of the opening, which acts as the pivot point, is located beyond the midpoint of the flange from the capsule wall to the flange edge to increase the moment of the forces being applied to the front surface of the capsule. A particularly preferred dimension for the opening is 52.4 mm, which allows for the pivot point to be 1.85 mm from the wall of the capsule, which reliably tears the Vertuo capsule foil.

The collar body 19 is provided with a depth to help flatten the whole portion of the capsule where the lid foil is likely to remain after inversion, reducing chance of trapped coffee. An exemplary depth for the collar is 14.5 mm. The angle of the pusher with respect to the vertical axis is smaller than that of the angle on the collar, i.e. closer to the vertical, so the capsule remains on the collar when the pusher is removed. This allows the user to easily pick up and remove the capsule. The collar opening profile may have a draft angle, eg 10°, on the surface allowing easy release of the capsule inside the collar compared to if there were no draft angle.

The pusher shown in FIG. 1 has a stepped profile having three sections, each of which is co-axial with the other sections. Each of the pusher sections has a smaller angle with respect to the vertical axis than the collar body but with a gradually reducing radius with an angled step being provided between the sections. The bottom of the pusher can be generally flat with a diameter of around 20 mm. The stepped arrangement advantageously allows the initial force of inversion to be reduced as the foil is torn and then once the pusher has some momentum on the downstroke, the wider portions of the pusher come into effect, forcing the coffee out. The coffee or residue can then fall into the receptacle and the now inverted capsule, which is largely free of coffee can be removed, rinsed if necessary and recycled.

It is preferable for the depth at which the pusher stops at to be adjustable so that all 3 sizes of capsule can be inverted. There are several ways this can be achieved.

It would be possible to have three separate pusher parts, so that the customer picks the one to use for the capsule being processed.

Alternatively it would be possible to have an interchangeable central section that can be swapped out for various height pushers. The pusher part could bayonet onto the lid to lock it in position. The customer would be given two other pusher parts, with varied length of plunger to be used for the other sizes of capsules.

As a further alternative, it would be possible to have an adjustable end stop. This would have the advantage of maintaining the structural integrity of the pusher, where the force is transmitted, whereas the end stop adjustment mechanism would be low load bearing. This could consist of a threaded ring that fits inside the pusher which pusher could be twisted into alternative positions that adjust the height of the end stop.

The table below shows the peak force required in contrast to the design shown in GB2586618. In addition the peak force is no longer required at the beginning of the stroke, which makes the device easier to use.

Final Push Force Results

| Design | Small Capsule | Medium Capsule | | Large Capsule | |
|---|---|---|---|---|---|
| GB2586618 | 19.6 kg | 21.8 | kg | 24.2 | kg |
| Final Design | 13.0 kg | 15 | kg | 19 | kg |

FIG. 3 shows a second embodiment suitable for Nespresso original capsules. As with the embodiment of FIG. 1, the recycler comprises a base unit 10 upon which sits a receptacle 12. The lower face 14 of the receptacle 12 is openable and the upper face is provided with first and second openings 15, 16 each of which has a respective downwardly depending collar 18 which is provided with a respective flange 17. The upper part 20 of the recycler functions as a lid and but is provided with first 22 and second pushers 23, which are substantially co-axial with the respective openings 15, 16.

Each of the pushers shown in FIG. 3 has a stepped profile having three sections, each of which is co-axial with the other sections. Each of the pusher sections has a smaller angle with respect to the vertical axis than the collar body but with a gradually reducing radius with an angled step being provided between the sections. The bottom of the pusher is generally flat with a diameter of around 8 mm. The stepped arrangement advantageously allows the initial force of inversion to be reduced as the foil is torn and then once the pusher has some momentum on the downstroke, the wider portions of the pusher come into effect, forcing the coffee out. Compared to the design known from GB2586618, there is an approximate 25-30% reduction in time required to invert the capsules but the force required is only 25% higher and within acceptable limits for consumers.

1. A device for separating beverage capsules, which beverage capsules have a wall, the device comprising a base unit (10) and a pusher (22), the base unit (10) having a face with an opening (16) for receiving a body part of a selected beverage capsule, characterised in that the pusher (22) comprises a projection sized to fit within the opening (16), the projection having a stepped profile having at least a first and a second section, wherein the pusher is dimensioned so that there is a clearance between the surface of the pusher and the opening (16).

2. The device for separating beverage capsules according to claim 1, wherein a face of the base unit (10) is provided with a flange (17) for supporting the body part of the selected beverage capsule prior to separation.

3. The device for separating beverage capsules according to claim 1, wherein an upstanding circumferential wall (21) is provided a short distance from an edge of the opening (16).

4. The device for separating beverage capsules according to claim 2, wherein an edge of the opening (16), which acts as the pivot point, is located beyond a midpoint of the flange (17) from the wall of the selected beverage capsule to the flange edge to increase the moment of the forces being applied to a front surface of the selected beverage capsule.

5. The device for separating beverage capsules according to claim 4, wherein the opening (16) diameter is between 48 and 54 mm.

6. The device for separating beverage capsules according to claim 1, wherein the projection comprises a stepped profile having three sections, each of which is substantially co-axial with the other sections.

7. The device for separating beverage capsules according to claim 6, wherein the opening has a downwardly depending collar and each of the pusher sections has a smaller angle with respect to the vertical axis than the collar.

8. The device for separating beverage capsules according to claim 6, wherein each of the pusher sections has a gradually reducing radius with an angled step being provided between the sections.

9. The device for separating beverage capsules according to claim 1, wherein the depth at which the pusher (22) stops is adjustable.

10. The device for separating beverage capsules according to claim 1, wherein the opening (16) has a reducing cross-section towards its lower face.
